(19) United States
(12) Patent Application Publication
(10) Pub. No.: US 2023/0309004 A1
(43) Pub. Date: Sep. 28, 2023

(54) RELAYING TECHNIQUES FOR D2D OR SIDELINK COMMUNICATIONS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/018,586

(22) PCT Filed: Aug. 5, 2021
(86) PCT No.: PCT/EP2021/071939

§ 371 Date: Jan. 30, 2023

(30) Foreign Application Priority Data
Aug. 6, 2020 (EP) 20189902.8

(51) Int. Cl. H04W 48/18; H04W 48/16

(52) U.S. Cl. CPC H04W 48/18; H04W 48/16

(57) ABSTRACT

There is provided a system for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station, the system comprising the communications node, wherein the communications node is configured to identify a requested service to be requested; the relay node, wherein the relay node is configured to identify a service supported by the relay node when connected to the base station; and a capability assessment function configured to determine whether the requested service and the supported service match.

### FIELD OF DISCLOSURE

The present disclosure relates to methods and apparatus for providing a service to a communications node (also referred to as a mobile node) via a relay node in a mobile telecommunications network. The present application claims the Paris Convention priority of European patent application EP 20189902.8, filed 6 Aug. 2020, the contents of which are hereby incorporated by reference.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Recent generation mobile telecommunication systems, such as those based on the 3GPP defined UMTS and Long Term Evolution (LTE) architectures, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. In addition to supporting these kinds of more sophisticated services and devices, it is also proposed for newer generation mobile telecommunication systems to support less complex services and devices which make use of the reliable and wide ranging coverage of newer generation mobile telecommunication systems without necessarily needing to rely on the high data rates available in such systems. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

The demand to deploy fifth generation networks is therefore strong and the coverage area of these networks, i.e. geographic locations where access to the networks is possible, is expected to increase rapidly. However, although the coverage and capacity of fifth generation networks is expected to significantly exceed those of previous generations of communications networks, there are still limitations on network capacity and the geographical areas that can be served by such networks. These limitations may, for example, be particularly relevant in situations in which there is a desire for a group of terminal devices (communications devices) to exchange information with each other in a fast and reliable manner. In order to help address these limitations there have been proposed approaches in which terminal devices within a wireless telecommunications system may be configured to communicate data directly with one another without some or all their communications passing through a base station element, such as a base station. Such communications are commonly referred to generally as a device-to-device (D2D) communications. Many device-to-device communications may be transmitted by one device to a plurality of other devices in a broadcast like manner and so in that sense the phrase “device-to-device communications” also covers “device-to-devices communications”.

Thus, D2D communications allow communications devices that are in sufficiently close proximity to directly communicate with each other, both when within the coverage area of a network and when outside a network's coverage area (e.g. due to geographic restrictions on a network's extent or because the network has failed or is in effect unavailable to a terminal device because the network is overloaded). D2D communications can allow user data to be more efficiently and quickly communicated between communications devices by obviating the need for user data to be relayed by a network entity such as a base station. D2D communications also allow communications devices to communicate with one another even when one or both devices may not be within the reliable coverage area of a network. The ability for communications devices to operate both inside and outside of coverage areas makes wireless telecommunications systems that incorporate D2D capabilities well suited to applications such as public protection/safety and disaster relief (PPDR), for example, PPDR related communications may benefit from a high degree of robustness whereby devices can continue to communicate with one another in congested networks and when outside a coverage area. 3GPP has developed some proposals for such public safety D2D use in LTE networks in Release 12.

In 3GPP systems, D2D communications techniques can be used to provide a relay arrangement where an intermediate node (a relay node) can interface wirelessly with a communications node (e.g. mobile node, communications device, terminal, UE/ME/WRTU/etc.) and relay communications between the communications node and the base station (e.g. eNB, gNB, etc.).

In particular, Release 14 also included D2D communications which involved using a D2D device as a relay, and such techniques were focussed on public safety use cases. In a somewhat similar development, Release 16 provided arrangements for D2D or sidelink communications which involved relays and where these arrangements were aimed at Vehicle-to-everything “V2X” services. Accordingly, present relaying techniques in 3GPP systems tend to be limited to a particular type of service and are not designed to handle more complex situations. There is therefore a desire to provide arrangements and techniques which can enable relaying techniques to support a greater variety of services.

### SUMMARY OF THE DISCLOSURE

The invention is defined in the independent claims. Further example embodiments are provided in the dependent claims.

According to a first example of the present disclosure, there is provided a system for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station, the system comprising the communications node, wherein the communications node is configured to identify a requested service to be requested; the relay node, wherein the relay node is configured to identify a service supported by the relay node when connected to the base station; and a capability assessment function configured to determine whether the requested service and the supported service match. The communications node is further configured to notify first capability information to the capability assessment function, wherein the first capability information comprises an identifier for the requested service; wherein the relay node is further configured to notify relay capability information to the capability assessment function, wherein the relay capability information comprises an identifier for the supported service; wherein the capability assessment function is configured to determine, based on a comparison of the first capability information and of the relay capability information, whether the communications node can use the requested service via the relay node and the base station; and wherein the communications node and relay node are configured to operate together to provide the requested service to the communications node via the base station and via the relay node.

For example the communications node may initiate the requested service and if the request is successful, the communications node can use the service, via the relay node and base station. In some examples, the service is provided to the communications node when the capability assessment function has determined that the communications node can use the requested service via the relay node and the base station.

According to a second example of the present disclosure, there is provided a communications node for use in a mobile telecommunications network, wherein the communications node is configured to connect to the mobile telecommunication network via a wireless interface provided by a relay node, where the relay node is configured to relay communications for the communications node via a base station of the mobile telecommunication network, when connected to the base station. The communications node is configured to identify a requested service to be requested; notify first capability information to a capability assessment function, wherein the capability information comprises at least an identifier for the requested service; when the requested service matches a service supported by the relay node when connected to the base station, use the requested service via the relay node and via the base station.

According to a third example of the present disclosure, there is provided a relay node for use in a mobile telecommunications network, wherein the relay node is configured to provide a wireless interface for a communications node to connect to the mobile telecommunication network and is configured to relay communications for the communications node via a base station of the mobile telecommunication network, when connected to the base station. The relay node being configured to identify a service supported by the relay node when connected to the base station; notify relay capability information to a capability assessment function, wherein the relay capability information comprises an identifier for the supported service; when the supported service matches a service requested by the communications node, provide the requested service to the communications node via the base station.

According to a fourth example of the present disclosure, there is provided a method for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station. The method comprises the communications node identifying a requested service to be requested; the relay node identifying a service supported by the relay node when connected to the base station; the communications node notifying first capability information to a capability assessment function, wherein the first capability information comprises an identifier for the requested service; the relay node notifying relay capability information to the capability assessment function, wherein the relay capability information comprises an identifier for the supported service; the capability assessment function determining, based on a comparison of the first capability information and of the relay capability information, that the communications node can use the requested service via the relay node and the base station; and the communications node and relay node, based on the determination, operating together to provide the requested service to the communications node via the base station and via the relay node.

According to a fifth example of the present disclosure, there is provided a method of operating a communications node in a mobile telecommunications network, wherein the communications node is configured to connect to the mobile telecommunication network via a wireless interface provided by a relay node, where the relay node is configured, when connected to the base station, to relay communications for the communications node via a base station of the mobile telecommunication network. The method comprises identifying a requested service to be requested; notifying first capability information to a capability assessment function, wherein the capability information comprises at least an identifier for the requested service; using, when the requested service matches a service supported by the relay node when the relay node is connected to the base station, the requested service via the relay node and via the base station.

According to a sixth example of the present disclosure, there is provided a method of operating a relay node in a mobile telecommunications network, wherein the relay node is configured to provide a wireless interface for a communications node to connect to the mobile telecommunication network and is configured to relay communications for the communications node via a base station of the mobile telecommunication network, when connected to the base station. The method comprises identifying a service supported by the relay node when connected to the base station; notifying relay capability information to a capability assessment function, wherein the relay capability information comprises an identifier for the supported service; providing, when the supported service matches a service requested by the communications node, the requested service to the communications node via the base station.

According to a seventh example of the present disclosure, there is provided circuitry for a communications node in a mobile telecommunications network, wherein the circuitry comprises a controller element and a transceiver element configured to operate together to connect to the mobile telecommunication network via a wireless interface provided by a relay node, where the relay node is configured, when connected to the base station, to relay communications for the communications node via a base station of the mobile telecommunication network. The controller element and the transceiver element are further configured to operate together to identify a requested service to be requested; notify first capability information to a capability assessment function, wherein the capability information comprises at least an identifier for the requested service; when the requested service matches a service supported by the relay node when connected to the base station, use the requested service via the relay node and via the base station.

According to an eighth example of the present disclosure, there is provided circuitry for a relay node in a mobile telecommunications network, wherein the circuitry comprises a controller element and a transceiver element configured to operate together to provide a wireless interface for a communications node to connect to the mobile telecommunication network and is configured to relay communications for the communications node via a base station of the mobile telecommunication network, when connected to the base station, wherein the controller element and the transceiver element are further configured to operate together to identify a service supported by the relay node when connected to the base station; notify relay capability information to a capability assessment function, wherein the relay capability information comprises an identifier for the supported service; when the supported service matches a service requested by the communications node, provide the requested service to the communications node via the base station.

It is to be understood that both the foregoing general description and the following detailed description are exemplary, but are not restrictive, of the present technology. The described example apparatuses, systems and methods, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a LTE-type wireless telecommunication;

FIG. 2 schematically represents some aspects of a new radio access technology (RAT) wireless communications system;

FIG. 3 is a schematic block diagram of some components of the wireless communications system shown in FIG. 2 in more detail;

FIG. 4 schematically represents some aspects of device-to-device (D2D) communications.

FIG. 5 is a flow diagram of an example method in accordance with techniques of the present disclosure; and

FIG. 6 is a schematic representation of a protocol stack for a conventional ProSe function.

### DESCRIPTION OF EXAMPLES

The following detailed description is not to be taken in a limiting sense, and the scope of the embodiments of the present invention is defined only by the claims. It is to be understood that drawings are not necessarily drawn to scale. Some examples of the present disclosure may not fall within the scope of the claims but these examples are useful for understanding the technical field of the invention and the context and teachings of the present disclosure.

### Long Term Evolution (LTE) Wireless Communications System

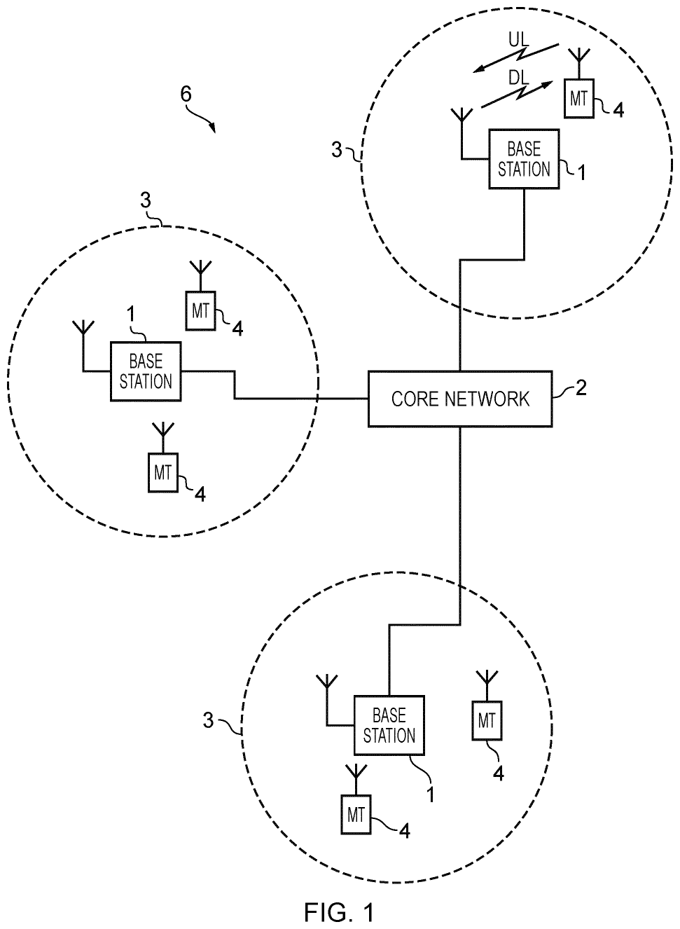

FIG. 1 provides a schematic diagram illustrating some basic functionality of a mobile telecommunications network/system 6 operating generally in accordance with LTE principles, but which may also support other radio access technologies, and which may be adapted to implement examples of the disclosure as described herein. While the present disclosure has been described in the context of NR and/or LTE, it will be appreciated that the teachings and techniques presented herein are not limited to these technologies, or to 3GPP technologies, and might be implemented in any suitable mobile telecommunications network. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. In the present disclosure, the term “base station” can be used interchangeably with “network infrastructure equipment”. However, certain examples of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

It will for example be appreciated that the architecture of FIG. 1 is applicable not only to LTE but to other mobile communications or mobile telecommunications standards or system, for example previous or later generations of mobile telecommunications network.

### New Radio Access Technology (5G) Wireless Communications System

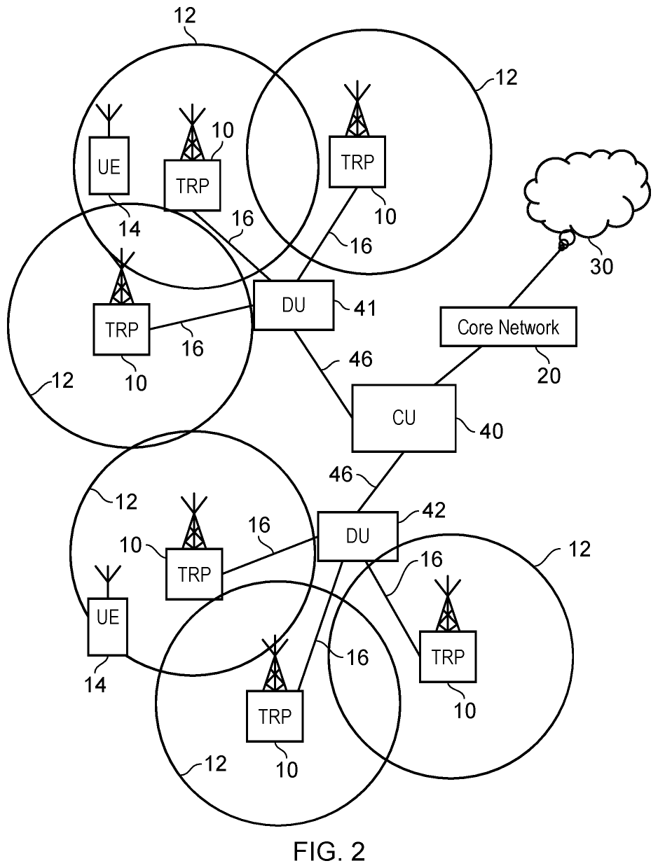

An example configuration of a wireless communications network which uses some of the terminology proposed for NR and 5G is shown in FIG. 2. A 3GPP Study Item (SI) on New Radio Access Technology (NR) has been defined [2]. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with examples of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term base station/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 212 via one of the distributed units 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus certain examples of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain examples of the disclosure may be described generally in the context of communications between base station/access nodes and a communications device, wherein the specific nature of the base station/access node and the communications device will depend on the network infrastructure for the implementation at hand. For example, in some scenarios the base station/access node may comprise a base station, such as an LTE-type base station 1 as shown in FIG. 1 which is adapted to provide functionality in accordance with the principles described herein, and in other examples the base station may comprise a control unit/controlling node 40 and/or a TRP 10 of the kind shown in FIG. 2 which is adapted to provide functionality in accordance with the principles described herein.

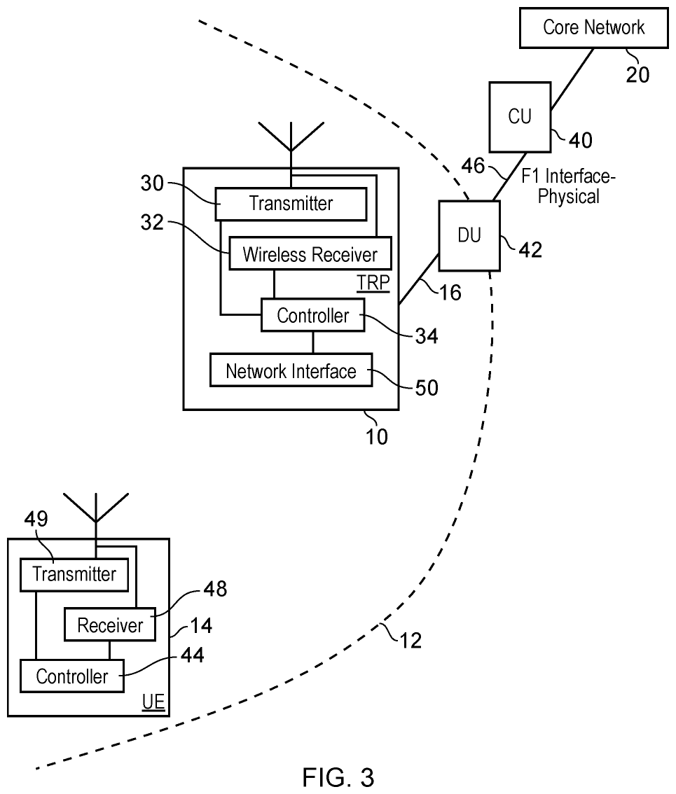

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples of the present disclosure) may include radio frequency filters and amplifiers as well as signal processing components and devices in order to transmit and receive radio signals in accordance for example with the 5G/NR standard. The controllers 34, 44 (as well as other controllers described in relation to examples of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Device-to-Device (D2D) and Sidelink Communications

Device-to-Device (D2D) communications is an aspect of mobile communications which has been established for devices to communicate directly with each other rather than via a wireless communications network. That is to say that radio signals representing data are transmitted via a wireless interface by one device and received by another to communicate that data, rather than the signals being transmitted to base station of a wireless communication network, which are then detected and decoded by the base station to recover that data and communicated on to a destination device.

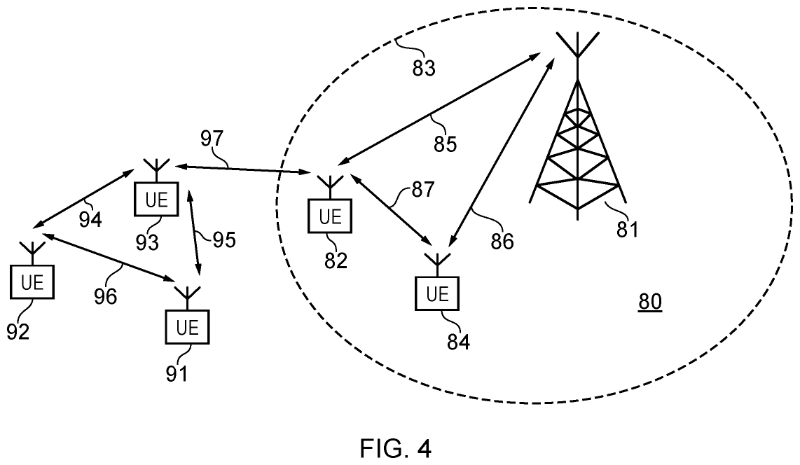

D2D communications can take different forms, which are illustrated in FIG. 4. As shown in FIG. 4, in one example two communications devices (UEs) 82, 84 are operating within a coverage area of a cell 80 provided by base station 81, which has a cell boundary 83 represented by a dashed line. The base station 81 may for example be a TRP 10 such as that shown in FIG. 2. As represented by double-headed arrows 85, 86, the UEs 82, 84, may transmit and receive signals to the base station 81 to transmit or to receive data on an uplink or a downlink respectively of a wireless access interface formed by a wireless communications network of which the base station 81 forms part. However within the radio coverage area of the cell 80 the UEs 82, 84 may communicate directly between one another via a D2D wireless access interface as represented by a double-headed arrow 87. The UEs 82, 84 can be configured to transmit and to receive signals via a D2D wireless access interface which may be separate and not shared or overlap a frequency band of the wireless access interface provided by the base station 81. Alternatively the UEs 82, 84 may transmit and receive signals via a part of the wireless access interface provided by the base station 81. A D2D wireless access interface formed for one UE to transmit radio signals to another UE is referred to as a sidelink or PC-5.

Another example of D2D communications is also shown in FIG. 4 where UEs fall outside a coverage area of a wireless communication network and so communicate directly with one another. As represented by dashed lines 94, 95, 96, three UEs 91, 92, 93 are operable to transmit and receive signals representing data via sidelinks. These sidelinks 94, 95, 96 may be formed by a D2D wireless access interface which falls within a frequency band of the base station 81 or may be outside this frequency band. However the UEs 91, 92, 93 organise access to a D2D wireless access interface autonomously without reference to a wireless access interface. In some cases, the UEs 91, 92, 93 may be pre-configured with some parameters for a D2D wireless access interface. As another example, one of the UEs 82 within the coverage area of the cell 80 acts as a relay node for one or more of the UEs 91, 92, 93 which are outside the coverage area as represented by a sidelink 97.

Here D2D communications of the form of sidelink 87 are referred to as in-coverage communications, D2D communications of the form of sidelink 97 are referred to as partial coverage communications, and

D2D communications of the form of sidelinks 94, 95, 96 are referred to as out-of-coverage communications.

According to 3GPP standards such as LTE, whilst downlink and uplink communications are specified for transmissions from a base station such as a gNB to a UE and from a UE to a gNB respectively, sidelink communications are specified to realise UE-to-UE (device-to-device (D2D)) communication, especially for sidelink discovery, sidelink communication and vehicle to everything (V2X) sidelink communication between UEs. The LTE sidelink has the following characteristics as described below, which are reproduced from [3]:
Sidelink comprises sidelink discovery, sidelink communication, and V2X sidelink communication between UEs;
Sidelink uses uplink resources and a physical channel structure similar to uplink transmissions. However, some changes, noted below, are made to the physical channels;
The sidelink/D2D wireless access interface structure includes a physical sidelink control channel (PSCCH) for UEs to transmit control signalling to other UEs and a physical sidelink shared channel (PSSCH) for transmitting data to other UEs. Control messages transmitted on the PSCCH can indicate communications resources of the PSSCH via which the UE will transmit data to another UE. The control message for sidelink is referred to as sidelink control information (SCI). Therefore the PSCCH is mapped to the sidelink control resources and indicates resource and other transmission parameters used by a UE for PSSCH;
Sidelink transmission uses the same basic transmission scheme as the uplink transmission scheme. However, sidelink is limited to single cluster transmissions for all the sidelink physical channels. Furthermore, sidelink uses a one symbol gap at the end of each sidelink sub-frame. For V2X sidelink communication, PSCCH and PSSCH are transmitted in the same subframe;
The sidelink physical layer processing of transport channels differs from uplink transmission in the following steps:
   Scrambling: for PSDCH and PSCCH, the scrambling is not UE-specific; and
   Modulation: 256 QAM is not supported for sidelink. 64 QAM is only supported for V2X sidelink communication;
For PSDCH (physical sidelink discovery channel), PSCCH and PSSCH demodulation, reference signals similar to uplink demodulation reference signals are transmitted in the fourth symbol of the slot in normal cyclic prefix (CP) and in the third symbol of the slot in extended cyclic prefix. The sidelink demodulation reference signals sequence length equals the size (number of sub-carriers) of the assigned resource. For V2X sidelink communication, reference signals are transmitted in the third and sixth symbols of the first slot and the second and fifth symbols of the second slot in normal CP;
For PSDCH and PSCCH, reference signals are created based on a fixed base sequence, cyclic shift and orthogonal cover code. For V2X sidelink communication, the cyclic shift for PSCCH is randomly selected in each transmission;
For in-coverage operation, the power spectral density of the sidelink transmissions can be influenced by the eNB; and
For measurement on the sidelink, the following basic UE measurement quantities are supported:
   Sidelink reference signal received power (S-RSRP);
   Sidelink discovery reference signal received power (SD-RSRP);
   PSSCH reference signal received power (PSSCH-RSRP); and
   Sidelink reference signal strength indicator (S-RSSI).
Currently, for 5G or New Radio (NR) standardisation, a sidelink has been specified in Release-16 for V2X communication, with the LTE sidelink being a starting point for the NR sidelink. For NR sidelink, the following sidelink physical channels are defined:
Physical Sidelink Shared Channel (PSSCH);
Physical Sidelink Broadcast Channel (PSBCH);
Physical Sidelink Control Channel (PSCCH); and
Physical Sidelink Feedback Channel (PSFCH).
Furthermore, the following sidelink physical signals are defined:
Demodulation reference signals (DM-RS);
Channel-state information reference signal (CSI-RS);
Phase-tracking reference signals (PT-RS);
Sidelink primary synchronization signal (S-PSS); and
Sidelink secondary synchronization signal (S-SSS).

As will be appreciated by a person skilled in the art, communication via a wireless access interface (for example, uplink/downlink communications or D2D communication) may occur over one of three types of planes: a user plane carrying network user traffic, a control plane carrying network signalling traffic or a management plane carrying operations and administration traffic required for network management. Alternatively, the management plane may be considered as part of the control plane. For the following disclosure, reference to the control plane should be understood as referring to either just the control plane or the control plane and the management plane together.

As will also be appreciated by a person skilled in the art, a wireless interface is implemented by a protocol stack. Since the control plane and the user plane carry different types of network traffic, the protocol stack implementing the wireless access interface may be different for the control plane and user plane for the same wireless access interface.

Relays

Relay UEs can be used in two example scenarios (among others) which are (1) the UE moving to or being outside the range of the radio coverage area of the gNB and (2) the relay enhancing the coverage for the UE, where the UE might be within coverage of the gNB but uses the relay to communications (e.g. if the quality or coverage are expected to be better through the relay compared to directly to the base station).

A UE that is connected to the network through a relay can sometimes be referred to as a remote UE, connected UE. In the interest of conciseness, the terms UE, communications node or mobile node will mostly be used to refer to this device but these are interchangeable. Likewise, the term relay will generally be used but it will be appreciated that it can refer to any type of relay node, for example a dedicated relay, a UE which can be activated as a relay, etc.

Limitations with current systems as discusses above include relay systems being designed to provide a single type of service of connectivity service to the remote UEs (the UEs connected to a relay node). On the other hands, there is a rising interest in provide multiple types of services through relay nodes. For example, in Release 16, it is expected that the further studies on sidelink UE relay will consider more advanced use cases with a number of different applications/services being potentially deploying on UE relays and/or on their associated base stations. With an increase flexibility regarding service availability, the complexity of managing such systems is also increased. For example, a remote UE may only want to initiate a particular service through the relay (e.g. a Virtual Reality “VR” service) but not all the services available. It should be noted that VR is an illustrative and non-limiting example and that the same considerations apply to other services, e.g. communication type services, slicing services, application-based services, etc. Accordingly:
(1) the UE can detect relays (or the base stations that a relay connects to) that may not be able to provide the services the UE wants to initiate. It is expected that some relays will be provided for supporting some specific applications or services. For example some relays can support VR services, on demand video etc. while other relays can support positioning assistance.
   A remote UE currently will generally try to connect this type of relay only when it wants to initiate such services. At this stage, a remote UE is not able to determine which service(s) are provided by a relay and it would thus have to connect to the relay and try to initiate the service or application before it can determine if the relay can support this service.
   it is also noteworthy that the same considerations apply for the base station: if the relay supports the service but it is connected to a base station which does not support this service, the relay is not expected to be able to support the service for remote UEs. It is also challenging for the remote UE to understand the base station's capabilities in this respect before initiating the service. With the challenges faced being at least in both at the relay node and at the base station, the UE cannot presently readily determine whether it can initiate a service when connected to a particular relay which is itself connected to a particular base station.
(2) Additionally, there are also cases where a remote UE is already connected to a relay and, while it is connected, it wishes to initiate a service (e.g. slice) that cannot actually be provided by existing remote UE-relay association (e.g. because of which services the relay is configured to support itself and/or because of which services the base station is configured to support). In such a case, it would be beneficial for the incompatibility to be detected before the UE tries to initiate the service.
(3) From a relay perspective, the relay may wish to adjust to which base station it connects (in cases where two or more base stations are within range) so that the relay can better serve its connected UEs.

Regarding items 2 and 3 and the appropriate pairing of a relay with a base station, different parameters and constrains for the relay can for example be taken into account for determining an appropriate relay-base station association:
Network
   Does the network supports the service (e.g. network slicing) the UE would like to use?
Radio resources
   PC5 resources: can the base station allocate enough resources for the relay to handle the service and keep required QoS for the service.
   Uu resources: does the traffic load of the base station allow the base station to provide the service and provide or maintain the relevant QoS? Or is the traffic load too high for the base station to handle the service and keep the required QoS?
Relay (UE) capability
   Device capability: does the relay support the capability(ies) required for handling the service? (e.g. maximum bit rate, latency, etc.).
   Service capability: does the relay support the function(s) which the service require the relay to implement? (e.g. positioning assistance).
Base station capability
   Device capability: does the base station support the capability(ies) required for handling the service? (e.g. maximum bit rate, latency, etc.). While the relay is expected to be generally more limited regarding device capacities compared to most base stations and while base stations will mostly be expected to have most of the required device capabilities, there could still be cases where the base station does not have a technical capability required for providing a service.
   Service capability: does the base station support the function(s) which the service require the relay to implement? (e.g. positioning assistance).

Accordingly, a new signalling and communication techniques which help with at least the above limitations of the current systems for example to assist a remote UE with discovering a relay that could provide a specific service or to assist a UE when the current UE is using a relay through which the service cannot currently be provided (and to assist with the identification of such situations). In some cases, a base station may be able to check the service request sent by the remote UE and if gNB or relay UE does not support the requested service then gNB or relay UE behaviour is not known.

It is also expected that in most cases, the initial authentication and authorization procedures will most likely be performed between the remote UE and base station and between the relay and base station, as in current sidelink procedure. The techniques of the present disclosure are compatible with such an arrangement.

The skilled reader is also directed to the discussion of NR sidelink relays which is included in Study Item document RP-193253 [4].

It is also noted that in the present disclosure, considerations and teachings regarding services apply equally to network slices, as network slices are expected, at least in some cases, to be associated with a service, such as a connectivity service.

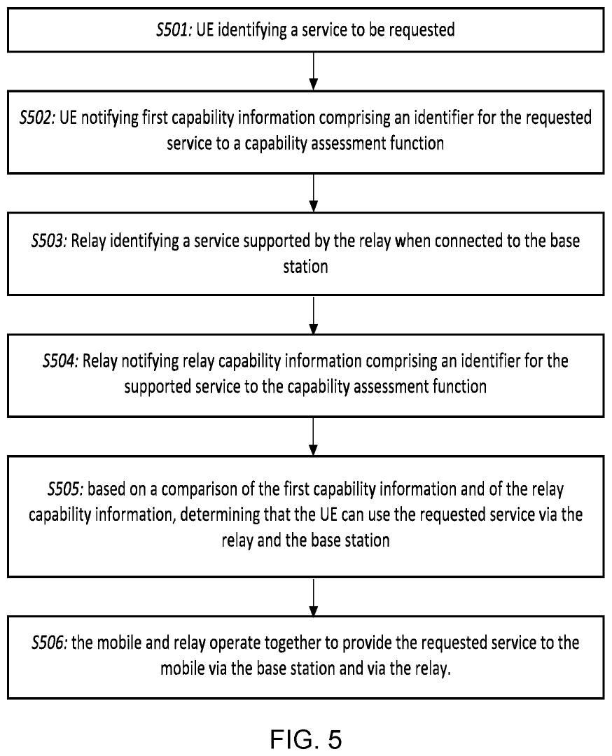

According to an example of the present disclosure, there is provided a method as illustrated in FIG. 5. It is noteworthy that in FIG. 5 and generally in the present disclosure method steps may be carried out in any suitable order, such as one after the other or at least partially in parallel. So long as an order for carrying any of the steps of any method discussed herein is technically feasible, it is explicitly encompassed within the present disclosure. For example, in the example below, steps S501-504 may be carried out in any suitable order before S505 and may be carried at different times or at (at least partially) overlapping times.

First, at step S501 the UE identifies a service to be requested, for example a service (e.g. a service, network slice, application) that the UE wishes to initiate. Once identified, the UE notifies a capability assessment function of first capability information comprising an identifier for the requested service.

In cases where the capability assessment function is not part of the UE, the UE can for example send the capability information using a discovery message, such as an adapted discovery message, a radio resource control “RRC” message or any other suitable message.

Likewise, the relay identifies at S503 a service supported by the relay when connected to the base station and at S504 the relay notifies the capability assessment function with relay capability information comprising an identifier for the supported service.

In cases where the capability assessment function is not part of the relay, the relay can for example send the capability information using a discovery message, such as an adapted discovery message, a radio resource control “RRC” message, broadcasted system information or any other suitable message.

The capability assessment function is a function, node or module configured to determine whether the requested service and the supported service match with a view to assessing the suitability UE-relay pairing. One or more configurations may be used for the capability assessment function, which can be used as alternative or in parallel. For example:
The capability assessment function will on some cases be found in the UE, where the relay can notify the UE of the service(s) it can support, if any, and where the UE can determining the suitability of the relay.
In other cases, the capability assessment function will be provided in the relay, where the relay can retrieve its own supported services—wherein storing the capability locally can thus be used to notify the capability assessment function of the relay of the relay's service capabilities (the same reasoning applies equally when the capability assessment function is provided in the UE). The relay may then also receive first/mobile capability information from the UE so that it can determine the pairing's suitability.
The capability assessment function may also be provided in a dedicated node, for example in node handling and comparing capabilities. In this case, the UE and relay would both be expected to send capability information.
In some cases, the capability assessment function may also be provided as part of the base station, for example to determine the suitability of a pairing and, if the pairing is suitable, for the base station to then attempt to reserve resources for the service without the need to use any additional external signalling.
The capability assessment function may also be distributed across two or more elements. In some examples, a UE-relay pairing may initially be assessed by the UE or by the relay while one or more further UE-relay pairing assessments may be assessed at another node (e.g. base station). For example, if the UE is already connected to a first relay which is not able to provide the desired service, then the base station can assess (e.g. upon notification or request) whether one or more other relays would be suitable for the UE to use the service. Accordingly and in this example, the further pairings may be assessed at the base station, even if the first pairing was assessed elsewhere.

Returning to the example of FIG. 5, at S505 and based on a comparison of the first capability information and of the relay capability information, the capability assessment function can determine that the UE can use the requested service via the relay and the base station The comparison can be done by identifying a match or where a score for the first capability information and relay capability information match passes a suitability test. A suitability test may be based on any combination of an absolute test (e.g. a score above or below a threshold) or a relative test (e.g. the base matching score for all relays within coverage of the UE or of all relays with a matching score above or below a threshold)

It is also noteworthy that in some examples the UE will not be connected to the relay when the pairing suitability assessment is carried out, i.e. the assessment is done prior to the UE connecting to the relay, while in other cases the UE will already be connected to the relay when the assessment is carried out.

While it is usually expected that carrying out the assessment prior to the connection to the relay will reduce the amount of signalling and possibly reduce the access time before the terminal can use the service, in some cases, setting up the relay connection first may be beneficial. For example, in cases where the UE is not within coverage of the UE or is at the boundary of the UE, connecting to the relay first may be beneficial, even if this first relay may not actually be able to provide the service that the terminal wishes to use.

At S506 the UE (or other communications node) can then use the requested service, via the relay node and the base station. For example, the UE can initiate the service, which is expected to be successful as the relay supports the service when connected to the base station (and in some cases, because the base station has been able to reserve resources for the service).

In some cases, the base station can determine (e.g. on request) whether sufficient resources are available for providing the supported service via the relay node. For example, this can be done when the relay capability information is shared by the relay with the base station or with another node (which can for example request the base station to make the determination.

In cases where the base station can for example make a decision of whether enough resources are available for the supported service to be provided via the relay, the resources may for example be one or more of: radio resources for communicating with the relay, radio resources for the relay to communicate with the UE (e.g. in cases where the base station is expected to schedule transmissions on the sidelink), internal resources within the base station (e.g. if this step is required or helpful for maintaining the expected Qos for the service).

In cases where sufficient resources are available, the base station can for example reserve a set of resources for providing the requested service.

Accordingly, by introducing new types of signalling, which may for example comprise RAN or discovery message, the suitability of a UE-relay pairing may be evaluated in the context of the base station connected to the relay and of the service the UE wishes to initiate.

Example illustrative arrangements in accordance with the present disclosure will now be discussed.

### Example 1—ProSe-Based Discovery

In some cases, existing ProSe functionalities may be adapted with a view to implementing techniques provided herein.

In such arrangements, the services (e.g. slices) that the UE wants to engage and/or the relay can provide or support can be included in the discovery message in the discovery phase. Based on the information exchanged in discovery messages, the UE or relay can decide whether to establish a corresponding association.

If re-using the ProSe function provided by 3GPP systems, the discovery message is generated by the ProSe function of the UE. In current systems, different names are defined for discovery messages depending on different type of discovery procedure. Namely, current messages comprise “ProSe Application Code” in model A and “ProSe Query Code” in model B. ProSe information, such as information regarding Model A and Model B can be found in 3GPP TS 23.303 [5].

According to techniques of the present disclosure, the discovery message, which are presently for detecting another node using ProSe, can be modified to include an application or service that the terminal wishes to use. The receiver of a discovery message can use a filter for detecting the relevant application for the UE (or from the relay, if appropriate) from discovery message.

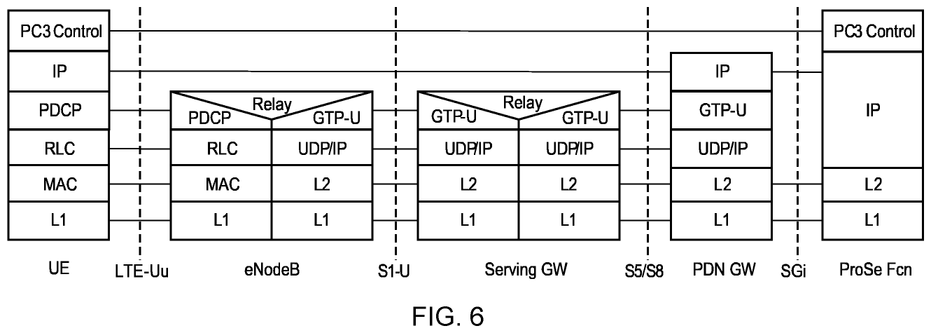

With reference to FIG. 6 (which corresponds to FIG. 5.1.1.2-1 of document [5]), it is noteworthy that ProSe messages, such as ProSe discovery messages, are transparent to Access Stratum “AS” layers. In a conventional D2D network, the ProSe function will be in charge of generating discovery message where the protocol stack for the ProSe function is illustrated in FIG. 6. Generally ProSe Control Signalling between UE and ProSe Function is carried over the user plane and is specified in TS 24.334 [6].

A discovery message can be generated by ProSe Function (from the “PC3 Control” layer) and sent to the UE (received by the PC3 Control layer). This message is entirely transparent for any intermediate nodes which merely carry the ProSe message without being able to access the content of the message as this content relates to higher layer information.

In accordance with the present disclosure, in cases where the discovery message is not sent to the relay or base station, the relay or base station may be configured to include one or more ProSe functionalities for them to be able to access the content of the discovery message. For example, if the UE includes slicing information in a ProSe message, the relay and/or base station on the path to the ProSe Function might be able to extract the slicing information from the discovery message and thus obtain information regarding a service that the UE wishes to initiate or use.

While this example uses ProSe as an example, it will appreciated that the same teachings apply to any other function which provides for discovery messages, for example a function where the UE communication with a node which is beyond the base station (and the relay, if used). It is also pointed that the PC3 Control layer may be implemented using one or more protocols.

In one example, a new control plane interface between the ProSe function and each appropriate intermediate node is provided. For example, new interface is defined between one or more of: the base station and the ProSe function, between the AMF and the ProSe Function between a slice specific SMF/UPF and the ProSe function, etc. The ProSe function can then collect information regarding radio resources, UE capability (e.g. for both the remote UE and relay UE), slicing or service information and so on, and can use the collected information during the discovery procedure, for example to generate a discovery message for the remote and/or relay UEs.

In cases where the (remote) UE wishes to indicate the relevant service using network slicing, the UE can use Single Network Slice Selection Assistance Information (S-NSSAI) to communicate this. In conventional networks, the network will send a list of S-NSSAI to a UE (where the UE can currently receive a maximum of eight S-NSSAIs). The UE can then be aware of supported slicing for the network. A conventional S-NSSAI is 32 bit long and comprises an 8-bit Slice/Service type (SST) and a 24-bit Slice Differentiator (SD). Additional information on the S-NSSAI can be found in TS 38.331 [7] (see the “S-NSSAI” sub-section in section 6.3.2) and in TS 23.003 [8] (see section “28.4.2 Format of the S-NSSAI”).

In one example the relay can send the discovery signal including S-NSSAI(s) or any other relevant service identifier identifying the services it supports. The network (e.g. ProSe or discovery function) may reduce the list of S-NSSAI in view of the received relay capability, network capacity and so on. A customized S-NSSAI list can then be provided to relay from ProSE or discovery function via the base station. Accordingly, the relay can then in the future advertise services that it can support and that it can support when connected to the base station.

However, current discovery information, for example ProSe discovery information is limited to discovering the presence of other UEs with a view to establishing a D2D connection with the UE. Accordingly, the discovery messages are relatively small messages which cannot accommodate extensive additional data. For example, current ProSe messages may not be able to accommodate a list of S-NSSAIs within the discovery message, especially if the discovery message is expected to include additional information from intermediate node beyond the S-NSSAI supported by the relay, the base station or requested by the (remote) UE.

Accordingly, in some examples, a truncated version of the S-NSSAI can be transmitted in discovery message. For example, the discovery signal may comprise information regarding the supported SST (or Non-supported SST) rather than the entire NS-SSAI. For example, if the UE support URLLC, but the relay does not support URLLC, the UE will not be able to request a URLLC service through this relay. The discovery information from the relay may for example enable the UE to determine whether the relay is a suitable relay or to determine that the relay is suitable for as long as the UE does not intend to use URLLC.

For example and using S-NSSAI truncated at the SST level, the S-NSSAI can be configured such that the SST can help the node to distinguish between the different services. In one illustrative example, SST 1 can identify an eMBB service, SST 2 an URLLC service and SST 3 a Massive MTC service. If the relay does not support URLLC, the relay can send the supported SSTs (#1, #3) in a discovery signal. Using this truncated identifier, while the same level of granularity may not be obtained compared to using the full identifier, this is expected to provide a suitable signification differentiating capacity, while the amount of signalling bits can be reduced by 24 bits (from a full S-NSSAI 32 bits to 8 bits).

In another example, rather than using the S-NSSAI, a more compact identifier may be used (which may be based on or derived from the S-NSSAI) by the relay to advertise its capabilities. For example, in a case where the number of services is limited to eMBB, URLLC, Massive MTC then a 3 bit identifier would be sufficient to indicate capabilities. In a case where the capability information is to indicate whether URLLC is supported or not, then a 1 bit would be sufficient.

Below are example a modified discovery procedures, inspired from the conventional discovery procedures as defined in TS 23.303 [5].

### Example 1-A (Model A D2D Discovery Based)

This model is based on the relay announcing its presence.

Relay UE (“Relay”) Process:
1. The relay sends the service(s) (Application ID) to the ProSe function via the base station.
2. The ProSe function requests the reservation of radio resources for the service to the base station so that the Prose function now has to check that there is enough radio resources to start the service.
3. The base station checks if enough radio resources are available for that relay to provide the service.
4. The ProSe function sends an application code back to the relay via base station (if there are enough resources).
5. The relay start broadcasting the discovery signal for that service to remote UEs (incluiding the Application code)

Remote UE (“UE”) Process (Discovery Request/Monitor/Matching):
1. The UE sends the service of interest (Application ID) to the ProSe function (via relay or directly to base station if in-coverage).
2. The ProSe function check the availability of relays for that service and via this base station.
3. The ProSe function sends back the application mask (which can be seen as a pattern which indicates the service) to the remote UE if the service is available.
4. The remote UE starts receiving the discovery signal from the ProSe function and checks the detection of application mask.
5. If the received discover signal matches the application mask, the remote UE recognizes that the relay can provides the service of interest.
6. The remote UE sends the matching result of service of interest to ProSe function.
7. The ProSe function sends the further information (so-called meta data like URL) to access the service.
8. The remote UE establishes the one-to-one connection with the relay and starts using the service.

In this case, once the case has reserved the resources, it will be for this base station to determine how to provide appropriate resources in order to support the required services and how to broadcast the relevant reserved resources.

### Example 1-B (Model B D2D Discovery Based)

Remote UE (“UE”) Process (Discoveree UE)
1. The remote UE receives the ProSe query code (which indicates the service of interest) in advance from ProSe function.
2. The remote UE sends the ProSe query code to neighbour relays to ask the service availability.
3. The remote UE monitors for the ProSe Query Code (response) from relays which can provide the service.
4. If remote UE detects the service (e.g. if the ProSe Query Code matches any of the Discovery Query Filter), the UE announces the associated ProSe Response Code.
5. The remote UE start using the service via relay.

Relay UE (“Relay”) Process (Discoverer UE)
1. The relay sends a discovery request and a service request to ProSe function in advance
2. The ProSe function requests the reservation of radio resources for the service with base station
3. The base station checks if enough radio resources are available for that relay to provide the service.
4. If the resource is available, the relay receives the related information for discovery from ProSe function.
5. The relay starts broadcasting the ProSe Query Code for remote UEs
6. The relay monitor the ProSe query code from other remote UEs.
7. If the relay detects the Discovery Response Filter (e.g. if a remote UE would like to use this service), the relay initiates the service.
8. The relay requests to use the pre-booked radio resources to base station.

### Example 1-C (EPC-Level ProSe Discovery Based)

This example is based on the proximity-based discovery techniques used in ProSe, which was originally devised as an EPC-level ProSe discovery was for WIFI direct service. To simplify the arrangement, a location server can identify when two UEs are in the proximity of each other and can for example start direct WIFI communications.

In accordance with the present disclosure, this can be adapted to be used to implement the tehcniques provided herein for service discovery in a relaying system based on a device-to-device communication system.

Process of EPC Based Discovery:
The relay registers the supported/offered service to ProSe function.
The remote UE registers the requested service to ProSe function
A proximity service starts in ProSe function (location server) to check the proximity between UEs.
The remote UE and relay both update their respective current location.
If remote UE is approaching the location of the relay, a proximity alert is sent to remote UE,
The ProSe function can include assistance information (e.g. available relays near it) for the service to remote UE.
The relay sends the service request to ProSe function via the base station.
The ProSe function requests the reservation of radio resources for the service with the base station
The base station checks if the enough radio resources for that relay to provide the service.

According to the techniques of the present disclosure, discovery messages can be modified to include service capability information, for example for a discovery function to compare, wherein the service capability information may comprise truncated service identifiers and wherein the base station may be requested to determine whether sufficient resources are expected to be available before the relay can confirm that it can provide the service via the base station.

### Example 2

In this further example, the service(s) that a relay can support can be included in system information which is broadcasted by the relay. For example, the system information can identify which services (or slices) it is able to support.

The teachings and techniques discussed above regarding compatibility with the base station can apply equally to this example: this information can be derived from relay's associated base station and can sometimes be dependent on the base station being able to reserve resources for the relay to provide the service to remote UEs.

Based on the system information sent by the relay, a remote UE can determine whether to establish an association with the UE relay.

### Example 3

In this example, a new type of RRC establishment signalling can be introduced between remote UE and UE relay. For example, in an RRC setup complete message or equivalent, the services (or slices) that the UE wishes to use can be indicated.

In this example and based on this information, the relay can notify the base station and the base station can select the relevant core network functions, for example which AMF or PCF the base station should connect to.

In some examples, a new Information Element “IE” can be added to existing PC5 RRC reconfiguration messages. The new IE can for example include the services or slices that the relay can support.

The skilled person will appreciate that in this and in general in accordance with the techniques of the present disclosure, the service(s) that a relay can support may change in time, for example if the relay is mobile (in a mobility sense) and for example performs a handover to another base station or for example if the base station (or relay) is no longer able to provide the resources required to support the service.

### Example 4

In this example, a UE is already connected to a relay and an example is considered where the current relay cannot support a service or slice that the terminal wishes to use.

In some cases, if the relay cannot provide the desired service, the relay can notify this to base station, for example by sending this notification within or alongside its measurement report. After receiving this notification, the base station may instruct the relay to hand-over to another base station which may provide such services. This type of handover instruction might be helpful if for example the base station directly and other relay(s) for this base station cannot support this service for the UE.

In some cases, if the remote UE cannot find a relay which can support its required service, the remote UE can notify this to base station, for example by sending this notification within or alongside its measurement report. After receiving this notification, the base station may instruct the remote UE to handover to another base station which is expected or believed to have one or more relays which can support required service. Optionally, the handover command may indicate the target base station as well as preferred relay associated with the target base station. Again, this type of instruction might be useful if it is expected that the base station and its relay(s) cannot support this service for the UE.

Another alternative is that remote UE can request the service via a Relay. The relay can then forward the service request to the base station and the base station can perform the handover for the relay itself if the serving base station does not support the requested slice or service but the relay supports the slice or service. In this case, if the relay-base station pairing does not enable the UE to use the service but the pairing of the same relay with another base station would enable it, sending a handover instruction to the relay would be beneficial. In a case where the relay performing a handover to another base station results in a break of the remote UE/relay association, the UE is likely to attempt to reconnect to the same relay once the relay is connected to its new base station. This is because the relay is usually selected as providing the best (e.g. PC5) link quality and in many cases, the relay will be expected to remain the best or optimal sidelink relay after the handover. This behaviour is also consistent with legacy systems where the remote UE is expected to select the relay based on an estimated best PC5 link quality.

If the relay and/or the serving base station are unable to identify a neighbouring candidate base station which can support the required slice or service (e.g. cannot provide the required QoS), the connection to the remote UE can then be released. In this case, the RRC Release or sidelink resource release message may in some cases instruct the remote UE to perform cell selection/reselection towards a particular carrier, for example based on frequency specific priorities or slice specific priorities, if it is expected that the remote UE would be more likely to use the service on this carrier.

Accordingly, in accordance with techniques of the present disclosure, when the capability information for the UE and for the relay (when connected to the base station) do not match, the UE and/or relay may be instruct to perform a handover to another base station or the UE may see its connection being released.

Therefore, in accordance with the techniques discussed herein, telecommunications system can be handle complex situation with relay nodes, different elements having different service capabilities and where resources may also limit the ability to support a service.

The following numbered clauses provide further example aspects and features of the present technique:

Clause 1. A system for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station, the system comprising:
the communications node, wherein the communications node is configured to identify a requested service to be requested;
the relay node, wherein the relay node is configured to identify a service supported by the relay node when connected to the base station; and
a capability assessment function configured to determine whether the requested service and the supported service match;
wherein the communications node is further configured to notify first capability information to the capability assessment function, wherein the first capability information comprises an identifier for the requested service;
wherein the relay node is further configured to notify relay capability information to the capability assessment function, wherein the relay capability information comprises an identifier for the supported service;
wherein the capability assessment function is configured to determine, based on a comparison of the first capability information and of the relay capability information, whether the communications node can use the requested service via the relay node and the base station; and wherein the communications node and relay node are configured to operate together to provide the requested service to the communications node via the base station and via the relay node.

Clause 2. The system of Clause 1 wherein the requested service and/or the identifier for the requested service identifies at least one of: a network slice, a low latency communication service, a high data communication rate service, a low power communication service, an emergency communications service, a high reliability communication service and an application-based service.

Clause 3. The network of any preceding Clause wherein the base station is configured to determine, on request and based on the relay capability information, whether sufficient resources are available for providing the supported service to the communications node via the relay node and to report and said determination.

Clause 4. The system of Clause 3 wherein, if it is determined that sufficient resources are not available, the relay node is configured to update its relay capability information to remove the supported service.

Clause 5. The system of any preceding Clause wherein the supported service and/or the identifier for the supported service identifies at least one of: a network slice, a low latency communication service, a high data communication rate, a low power communication service, a high reliability communication service, an application-based service and an emergency communications service.

Clause 6. The system of any preceding Clause wherein one or both of the identifier for the requested service and the identifier for the supported service comprises a truncated Single Network Slice Selection Assistance Information “S-NSSAI” for the network slice associated with the requested service.

Clause 7. The system of Clause 6 wherein the truncated S-NSSAI is 8 bit long and comprises the Slice/Service type “SST” for the S-NSSAI.

Clause 8. The system of any preceding Clause wherein the capability assessment function is comprised in:
the communications node;
the relay node; and
a capability node configured to receive the capability information from the communications node and from the relay node.

Clause 9. The system of Clause 8 wherein the capability node is comprised in one or more of: the base station;
a standalone node;
an application node; and
a ProSe function.

Clause 10. The system of any preceding Clause wherein the first capability information is transmitted at least in part within one or more of:
a discovery message transmitted by the communications node;
a capability registration message transmitted by the communications node to the capability assessment function; and
a radio resource control message transmitted by the communications node, wherein the radio resource control message is transmitted on the uplink or on the sidelink.

Clause 11. The system of any preceding Clause wherein the relay capability information is transmitted at least in part within one or more of:
a discovery message transmitted by the relay node;
a capability registration message transmitted by the relay node to capability assessment function;
system information transmitted by the relay node; and
a radio resource control message transmitted by the relay node, wherein the radio resource control message is transmitted on the uplink or on the sidelink.

Clause 12. The system of any preceding Clause wherein the terminal is configured to communicate discovery information using a discovery function and to communicate with a discovery function node via the base station and wherein at least one of the relay node and base station are configured to:
implement at least a partial discovery function for the at least one of the relay node and base station to read the content of discovery function messages;
modify a discovery function message discovery function node associated with the communications node to include relay information in the modified discovery function message.

Clause 13. The system of any preceding Clause wherein the terminal is configured to communicate discovery information using a discovery function and to communicate with a discovery function node via the base station and wherein at least one of the relay node and base station are configured to:
implement at least a partial discovery function for the at least one of the relay node and base station to read the content of discovery function messages;
extract the first capability information from a discovery function message associated with the communications node.

Clause 14. The system of any preceding Clause wherein the relay node is configured to identify the supported service when connected to the base station based on a first set of one or more services supported by the base station and on a second set of one or more services supported by the relay node.

Clause 15. The system of any preceding Clause wherein the base station is configured to, when the first capability information and the relay capability information do not match, to carry out one or more of:
instruct the communications node to handover to another base station;
instruct the relay node to handover to another base station; and
release the connection of the communications node.

Clause 16. The system of Clause 15 wherein the base station being configured to release the connection of the communications node comprises the base station being configured to transmit a connection release message to the communications node, the connection release message comprising frequency information indicative of at least one frequency band; and
wherein the communications node is configured to reconnect to the mobile telecommunications network using one of the at least one frequency bands.

Clause 17. A communications node for use in a mobile telecommunications network, wherein the communications node is configured to connect to the mobile telecommunication network via a wireless interface provided by a relay node, where the relay node is configured to relay communications for the communications node via a base station of the mobile telecommunication network, when connected to the base station, the communications node being configured to:
identify a requested service to be requested;
notify first capability information to a capability assessment function, wherein the capability information comprises at least an identifier for the requested service;
when the requested service matches a service supported by the relay node when connected to the base station, use the requested service via the relay node and via the base station.

Clause 18. The communications node of Clause 17 wherein the communications node comprises the capability assessment function and is further configured to:
receive relay capability information from the relay node, wherein the relay capability information comprises an identifier for a service supported by the relay node when connected to the base station; determine whether the supported service matches the requested service;
when the supported service matches the requested service, request the use of the service via the relay node.

Clause 19. The communications node of Clause 18 wherein the relay capability information is received in a discovery message, system information or a radio resource control message.

Clause 20. A relay node for use in a mobile telecommunications network, wherein the relay node is configured to provide a wireless interface for a communications node to connect to the mobile telecommunication network and is configured to relay communications for the communications node via a base station of the mobile telecommunication network, when connected to the base station, the relay node being configured to:
identify a service supported by the relay node when connected to the base station;
notify relay capability information to a capability assessment function, wherein the relay capability information comprises an identifier for the supported service;
when the supported service matches a service requested by the communications node, provide the requested service to the communications node via the base station.

Clause 21. The relay node of Clause 20 wherein the relay node comprises the capability assessment function and is further configured to:
receive mobile capability information from the communications node, wherein the mobile capability information comprises an identifier for a service to be requested by the communications node;
determine whether the supported service matches the requested service;
when the supported service matches the requested service, request to the base station the reservation of resources for providing the service to the communications node.
upon receipt of a confirmation that the set of resources has been reserved by the base station for providing the requested service, provide the requested service to the communications node using the reserved set of resources

Clause 22. The relay node of Clause 21 wherein the mobile capability information is received in a discovery message or a radio resource control message.

Clause 23. The relay node of any one of Clauses 20 to 22, wherein the relay node is configured to provide the requested service when a group of resources has been reserved by the base station for providing the requested service, wherein the requested service is provided using the reserved group of resources.

Clause

24. A method for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station, the method comprising:
the communications node identifying a requested service to be requested;
the relay node identifying a service supported by the relay node when connected to the base station;
the communications node notifying first capability information to a capability assessment function, wherein the first capability information comprises an identifier for the requested service;
the relay node notifying relay capability information to the capability assessment function, wherein the relay capability information comprises an identifier for the supported service;
the capability assessment function determining, based on a comparison of the first capability information and of the relay capability information, that the communications node can use the requested service via the relay node and the base station; and
the communications node and relay node, based on the determination, operating together to provide the requested service to the communications node via the base station and via the relay node.

Clause 25. The method of Clause 24 wherein the method further comprises step which, when implemented, cause the communications node, relay node and capability assessment function to operate in accordance with the system of any of Clauses 1 to 16.

Clause 26. A method of operating a communications node in a mobile telecommunications network, wherein the communications node is configured to connect to the mobile telecommunication network via a wireless interface provided by a relay node, where the relay node is configured, when connected to the base station, to relay communications for the communications node via a base station of the mobile telecommunication network, the method comprising:
identifying a requested service to be requested;
notifying first capability information to a capability assessment function, wherein the capability information comprises at least an identifier for the requested service;
using, when the requested service matches a service supported by the relay node when the relay node is connected to the base station, the requested service via the relay node and via the base station.

Clause 27. The method of Clause 26 wherein the method further comprises step which, when implemented, cause the communications node to operate in accordance with the communications node of any of Clauses 17 to 19 or with the communications node of the system of any of Clauses 1 to 16.

Clause 28. A method of operating a relay node in a mobile telecommunications network, wherein the relay node is configured to provide a wireless interface for a communications node to connect to the mobile telecommunication network and is configured to relay communications for the communications node via a base station of the mobile telecommunication network, when connected to the base station, the method comprising:
identifying a service supported by the relay node when connected to the base station;
notifying relay capability information to a capability assessment function, wherein the relay capability information comprises an identifier for the supported service;
providing, when the supported service matches a service requested by the communications node, the requested service to the communications node via the base station.

Clause 29. The method of Clause 28 wherein the method further comprises step which, when implemented, cause the relay node to operate in accordance with the relay node of any of Clauses 20 to 23 or with the relay node of the system of any of Clauses 1 to 16.

Clause 30. Circuitry for a communications node in a mobile telecommunications network, wherein the circuitry comprises a controller element and a transceiver element configured to operate together to connect to the mobile telecommunication network via a wireless interface provided by a relay node, where the relay node is configured, when connected to the base station, to relay communications for the communications node via a base station of the mobile telecommunication network, and wherein the controller element and the transceiver element are further configured to operate together to identify a requested service to be requested;
notify first capability information to a capability assessment function, wherein the capability information comprises at least an identifier for the requested service;
when the requested service matches a service supported by the relay node when connected to the base station, use the requested service via the relay node and via the base station.

Clause 31. The Circuitry of Clause 30 wherein and wherein the controller element and the transceiver element are further configured to operate together to implement the method of Clauses 26 or 27.

Clause 32. Circuitry for a relay node in a mobile telecommunications network, wherein the circuitry comprises a controller element and a transceiver element configured to operate together to provide a wireless interface for a communications node to connect to the mobile telecommunication network and is configured to relay communications for the communications node via a base station of the mobile telecommunication network, when connected to the base station, wherein the controller element and the transceiver element are further configured to operate together to identify a service supported by the relay node when connected to the base station;
notify relay capability information to a capability assessment function, wherein the relay capability information comprises an identifier for the supported service;
when the supported service matches a service requested by the communications node, provide the requested service to the communications node via the base station.

Clause 33. The Circuitry of Clause 32 wherein and wherein the controller element and the transceiver element are further configured to operate together to implement the method of Clause 28 or 29.

It will be appreciated that the above description for clarity has described examples with reference to different functional units, circuitry and/or processors. However, it will be apparent that any suitable distribution of functionality between different functional units, circuitry and/or processors may be used without detracting from the examples.

Described examples may be implemented in any suitable form including hardware, software, firmware or any combination of these. Described examples may optionally be implemented at least partly as computer software running on one or more data processors and/or digital signal processors. The elements and components of any example may be physically, functionally and logically implemented in any suitable way. Indeed the functionality may be implemented in a single unit, in a plurality of units or as part of other functional units. As such, the disclosed examples may be implemented in a single unit or may be physically and functionally distributed between different units, circuitry and/or processors.

Although the present disclosure has been described in connection with some examples, it is not intended to be limited to the specific form set forth herein. Additionally, although a feature may appear to be described in connection with particular examples, one skilled in the art would recognise that various features of the described examples may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-161901, “Revised work item proposal: Enhancements of NB-IoT”, Huawei, HiSilicon, 3GPP TSG RAN Meeting #73, New Orleans, USA, Sep. 19-22, 2016.
[3] TS 36.300, “Evolved Universal Terrestrial Radio Access (E-UTRA) and Evolved Universal Terrestrial Radio Access Network (E-UTRAN); Overall description; Stage 2 (Release 16, v16.0.0)”, 3GPP, January 2020.
[4] RP-193253 “Study on NR Sidelink Relay”, Sitges, Spain, Dec. 9-12, 2019
[5] TS 23.303 “Technical Specification Group Services and System Aspects; Proximity-based services (ProSe); Stage 2” (Release 16, v16.0.0), July 2020
[6] TS 24.334 “Technical Specification Group Core Network and Terminals; Proximity-services (ProSe) User Equipment (UE) to ProSe function protocol aspects; Stage 3” (Release 16, v.16.0.0), July 2020
[7] TS 38.331 “Technical Specification Group Radio Access Network; NR; Radio Resource Control (RRC) protocol specification” (Release 16, v.16.1.0), July 2020
[8] TS 23.003 “Technical Specification Group Core Network and Terminals; Numbering, addressing and identification” (Release 16, v.16.3.0), June 2020

1. A system for providing a service to a communications node via a relay node in a mobile telecommunications network, wherein the communications node is configured to connect to the mobile telecommunication network via a wireless interface provided by a relay node and wherein the relay node is configured to relay communications for the communications node via a base station of the mobile telecommunication network, when connected to the base station, the system comprising:
the communications node, wherein the communications node is configured to identify a requested service to be requested;
the relay node, wherein the relay node is configured to identify a service supported by the relay node when connected to the base station; and
a capability assessment function configured to determine whether the requested service and the supported service match;
wherein the communications node is further configured to notify first capability information to the capability assessment function, wherein the first capability information comprises an identifier for the requested service;
wherein the relay node is further configured to notify relay capability information to the capability assessment function, wherein the relay capability information comprises an identifier for the supported service;
wherein the capability assessment function is configured to determine, based on a comparison of the first capability information and of the relay capability information, whether the communications node can use the requested service via the relay node and the base station; and
wherein the communications node and relay node are configured to operate together to provide the requested service to the communications node via the base station and via the relay node.

2. The system of claim 1 wherein the requested service and/or the identifier for the requested service identifies at least one of: a network slice, a low latency communication service, a high data communication rate service, a low power communication service, an emergency communications service, a high reliability communication service and an application-based service.

3. The network of claim 1 wherein the base station is configured to determine, on request and based on the relay capability information, whether sufficient resources are available for providing the supported service to the communications node via the relay node and to report and said determination.

4. The system of claim 3 wherein, if it is determined that sufficient resources are not available, the relay node is configured to update its relay capability information to remove the supported service.

5. The system of claim 1 wherein the supported service and/or the identifier for the supported service identifies at least one of: a network slice, a low latency communication service, a high data communication rate, a low power communication service, a high reliability communication service, an application-based service and an emergency communications service.

6. The system of claim 1 wherein one or both of the identifier for the requested service and the identifier for the supported service comprises a truncated Single Network Slice Selection Assistance Information “S-NSSAI” for the network slice associated with the requested service.

7. The system of claim 6 wherein the truncated S-NSSAI is 8 bit long and comprises the Slice/Service type “SST” for the S-NSSAI.

8. The system of claim 1 wherein the capability assessment function is comprised in:
the communications node;
the relay node; and
a capability node configured to receive the capability information from the communications node and from the relay node.

9. The system of claim 8 wherein the capability node is comprised in one or more of:
the base station;
a standalone node;
an application node; and
a ProSe function.

10. The system of claim 1 wherein the first capability information is transmitted at least in part within one or more of:
a discovery message transmitted by the communications node;
a capability registration message transmitted by the communications node to the capability assessment function; and
a radio resource control message transmitted by the communications node, wherein the radio resource control message is transmitted on the uplink or on the sidelink.

11. The system of claim 1 wherein the relay capability information is transmitted at least in part within one or more of:
a discovery message transmitted by the relay node;
a capability registration message transmitted by the relay node to capability assessment function;
system information transmitted by the relay node; and
a radio resource control message transmitted by the relay node, wherein the radio resource control message is transmitted on the uplink or on the sidelink.

12. The system of claim 1 wherein the terminal is configured to communicate discovery information using a discovery function and to communicate with a discovery function node via the base station and wherein at least one of the relay node and base station are configured to:
implement at least a partial discovery function for the at least one of the relay node and base station to read the content of discovery function messages;
modify a discovery function message discovery function node associated with the communications node to include relay information in the modified discovery function message.

13. The system of claim 1 wherein the terminal is configured to communicate discovery information using a discovery function and to communicate with a discovery function node via the base station and wherein at least one of the relay node and base station are configured to:
implement at least a partial discovery function for the at least one of the relay node and base station to read the content of discovery function messages;
extract the first capability information from a discovery function message associated with the communications node.

14. The system of claim 1 wherein the relay node is configured to identify the supported service when connected to the base station based on a first set of one or more services supported by the base station and on a second set of one or more services supported by the relay node.

15. The system of claim 1 wherein the base station is configured to, when the first capability information and the relay capability information do not match, to carry out one or more of:
instruct the communications node to handover to another base station;
instruct the relay node to handover to another base station; and
release the connection of the communications node.

16. The system of claim 15 wherein the base station being configured to release the connection of the communications node comprises the base station being configured to transmit a connection release message to the communications node, the connection release message comprising frequency information indicative of at least one frequency band; and
wherein the communications node is configured to reconnect to the mobile telecommunications network using one of the at least one frequency bands.

17. A communications node for use in a mobile telecommunications network, wherein the communications node is configured to connect to the mobile telecommunication network via a wireless interface provided by a relay node, where the relay node is configured to relay communications for the communications node via a base station of the mobile telecommunication network, when connected to the base station, the communications node being configured to:
identify a requested service to be requested;
notify first capability information to a capability assessment function, wherein the capability information comprises at least an identifier for the requested service;
when the requested service matches a service supported by the relay node when connected to the base station, use the requested service via the relay node and via the base station.

18. The communications node of claim 17 wherein the communications node comprises the capability assessment function and is further configured to:
receive relay capability information from the relay node, wherein the relay capability information comprises an identifier for a service supported by the relay node when connected to the base station;
determine whether the supported service matches the requested service;
when the supported service matches the requested service, request the use of the service via the relay node.

19. The communications node of claim 18 wherein the relay capability information is received in a discovery message, system information or a radio resource control message.

20. A relay node for use in a mobile telecommunications network, wherein the relay node is configured to provide a wireless interface for a communications node to connect to the mobile telecommunication network and is configured to relay communications for the communications node via a base station of the mobile telecommunication network, when connected to the base station, the relay node being configured to:
identify a service supported by the relay node when connected to the base station;
notify relay capability information to a capability assessment function, wherein the relay capability information comprises an identifier for the supported service;
when the supported service matches a service requested by the communications node, provide the requested service to the communications node via the base station.

21.-28. (canceled)
